(19) United States
(12) Patent Application Publication
(10) Pub. No.: US 2004/0179043 A1
(43) Pub. Date: Sep. 16, 2004

(54) Method and system for animating a figure in three dimensions

(76) Inventors: Serge Viellescaze, Paris (FR); Benoit Morel, Paris (FR)

Correspondence Address: BANNER & WITCOFF, 1001 G STREET N W, SUITE 1100, WASHINGTON, DC, 20001, US

(21) Appl. No.: 10/474,793

(22) PCT Filed: Apr. 12, 2002
(86) PCT No.: PCT/FR02/01285

(30) Foreign Application Priority Data
Apr. 13, 2001 (FR) 01/05149

(51) Int. Cl. G09G 5/00

(52) U.S. Cl. 345/861

(57) ABSTRACT

The invention relates to a method and a system enabling a user to animate an interactive 3D figure known as an agent (2) during an application program, said agent being cut out of the background of the graphic interface of the program from which it is independent. A first file comprising data defining the agent and the animation algorithms thereof is created in a manner known per se. Said data comprises color, texture and meshing parameters relating to the agent. The first file is interpreted by calculating the behavioral parameters of the agent (2) in real time by means of a 3D motor 3D (23, 24) based on recognition of key words pronounced and/or written by the user in order to automatically animate the agent according to predetermined criteria corresponding to said key words or a combination of said key words.

The present invention relates to a method for user animation of an interactive character in three dimensions, or 3D character, referred to as an agent, for use during the running of an application program, the agent standing out from the background of the graphical interface of the program, from which it is independent.

It also relates to a computer system implementing such a method.

It has a particularly important, although not exclusive, application in the field of communication between a user and a computer program, for example in order to assist or entertain the user while the program is operating, for example on the Internet network.

A method making it possible for a character to be displayed in an application program is already known, which character stands out from the graphical interface of said program and has its behavior modified as a function of predetermined parameters, such as for example the elapsed time or alternatively an action by the user on a softkey, a mouse click etc.

Such a method nevertheless has drawbacks.

This is because the character is inexpressive, and the programming of its behavior requires intervention by a computing specialist capable of programming different scripts of the character by using fairly complex tools.

It is an object of the present invention to provide a method and a system which meet with practical requirements better than those previously known, especially in that it makes it possible to animate an agent or character in a particularly straightforward and lifelike way, on the basis of a written or oral text generated by a user who is not a professional director.

By virtue of the invention, the user will therefore be able to direct a character without special skills, on the basis of the text which he or she can say or edit himself or herself, so that said character can move or be animated at the right time, and to do so while appropriately introducing the commands for movement animation and/or modification of the intonation of the voice of the agent.

An agent realized by using the invention moreover appears on the screen without being contained in a window, which allows it to be placed anywhere on the screen without interfering with the elements of the interface.

It is advantageously connected to an interactive dialog balloon making it possible to progressively display some scrolling text, as well as interface elements such as actuator buttons, scrolling lists, etc.

The design features of the agent itself are known. The character is in fact created by standard software such as, for example, the software marketed by the companies SOFTIMAGE, MAYA, 3D STUDIOMAX or LIGHT WAVE.

Such software is of the type used by graphics studios to produce cartoons, films or videogames.

It makes it possible, as in the cinema, to bring characters to life with respect to scenery, a camera and/or a lighting effect.

With a view to overcoming the drawbacks of the prior art, the present invention therefore provides, in particular, a method for user animation of an interactive 3D character, referred to as an agent, suitable for being used during the running of an application program, the agent standing out from the background of the graphical interface of the program, from which it is independent, in which method a first file is created containing the data defining the agent and its animation algorithms in a manner which is known per se, said data including the parameters for colors, texture and mesh of the agent,

characterized in that this first file is interpreted by calculating the behavior parameters of the agent in real time using a 3D engine based on recognition of keywords spoken and/or written by the user, in order to automatically animate said agent as a function of predetermined criteria corresponding to said keywords or to a combination of said keywords.

The term keyword should essentially be understood as meaning a word of determined vocabulary, a term of determined semantic significance (family of words) one or more punctuation marks, a sequence of words uninterrupted by punctuation and/or an image or drawing.

In advantageous embodiments, one and/or other of the following provisions are furthermore employed:

the first file is downloaded from at least one site which is present on the Internet;

the user interacts with the agent by filling interactive balloons;

the keywords are auto-generated at least in part by a behavioral intelligence engine based on a dynamic dictionary of words and word associations;

the text provided by the user is analyzed in order to determine the moment or moments at which commands of the agent are inserted, namely its animation, its movement or modification of the intonation of its voice, on the basis of the rhythm of the text, namely its general movement which results from the relative length of the members of the sentence and/or the use of a tonic stress;

the rhythm of the text includes a plurality of parameters taken into account by the calculation, from among the grammatical rhythm, the rhythm of the meaning, the punctuation and/or the breathing;

the rhythm of the sentences of the text which is used is analyzed relative to the size of the paragraph of which they form part, by using one or more so-called fuzzy parameters;

the fuzzy parameter is taken from among the following parameters: valuation, length of the paragraph with respect to the rest of the text, liveliness, screen space ratio, type, relative length of a sentence, parentheses and/or commas;

a style parameter is assigned to the agent, namely a parameter dependent on the means of expression of the language specific to said agent;

the style parameters used for defining the animation are so used according to a predetermined intensity scale, and are taken from among the liveliness, calm or nervous state, mobility;

the moment at which to insert or send a command, and which command to send, are decided on the basis of the analysis of the text and the style which are intended by the user;

the analysis of the text and of the sequence of paragraphs, and/or also the analysis of each paragraph and of the sequence of the sentences weighting these values in respect of said paragraphs, and/or the analysis of the sentences and of the punctuation sequences within the sentences weighting said values, in respect of said sentences, initializes the values which are used in order to determine the threshold beyond which the command or commands will be transmitted;

the commands are selected from among the following operations: move, show, modify voice, pause, resend, explain, interpellate, interrogate.

The invention also provides a system for user animation of an interactive 3D character employing the method described above.

The invention furthermore provides a system for user animation of an interactive 3D character, referred to as an agent, for use during the running of an application program, said agent standing out from the background of the graphical interface of said program, from which it is independent, which system comprises a first file containing the data defining the agent and its animation algorithms in a manner which is known per se, said data including the parameters for colors, texture and mesh of said agent, characterized in that it comprises

means for storing said first file,

search, calculation and analysis means for interpreting this first file by calculating the behavior parameters of the agent in real time, said means comprising a 3D engine based on recognition of keywords spoken and/or written by the user,

means for voice and/or other recognition, for example via a written alphabet, of said keywords by the user,

and display means designed to automatically animate said agent, on the basis of said 3D engine, as a function of predetermined criteria corresponding to said keywords or to a combination of said keywords.

Advantageously, the system includes means for auto-generating keywords at least in part, these means comprising a behavioral intelligence engine based on a dynamic dictionary of words and word associations.

In one advantageous embodiment, the system comprises means for analyzing the text provided by the user in order to determine the moment or moments at which commands of the agent are inserted, namely its animation, its movement or modification of the intonation of its voice, on the basis of the rhythm of the text, namely its general movement which results from the relative length of the members of the sentence and/or the use of a tonic stress.

The invention will be understood more clearly on reading the description of the embodiments which are given below by way of nonlimiting examples.

It refers to the drawings which accompany it, in which:

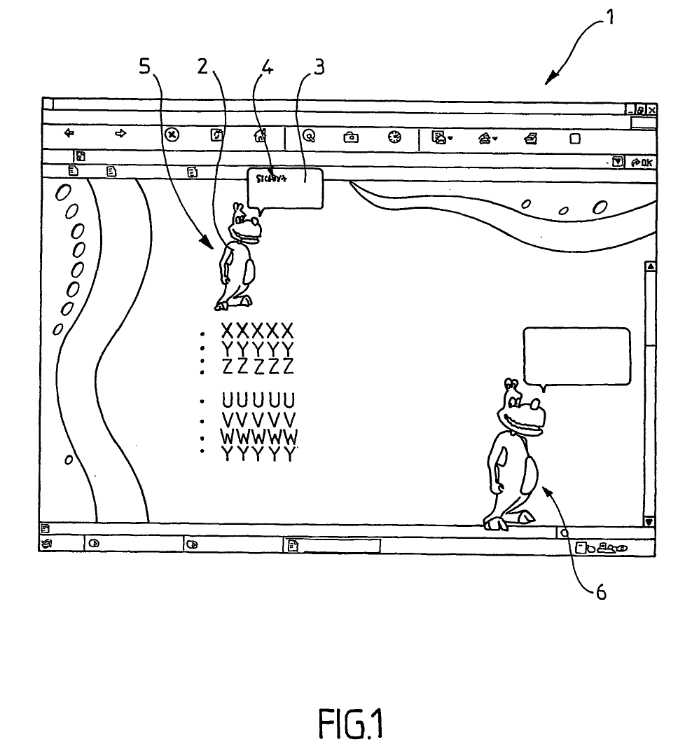

FIG. 1 shows the screen containing an animated agent according to one embodiment of the method of the invention.

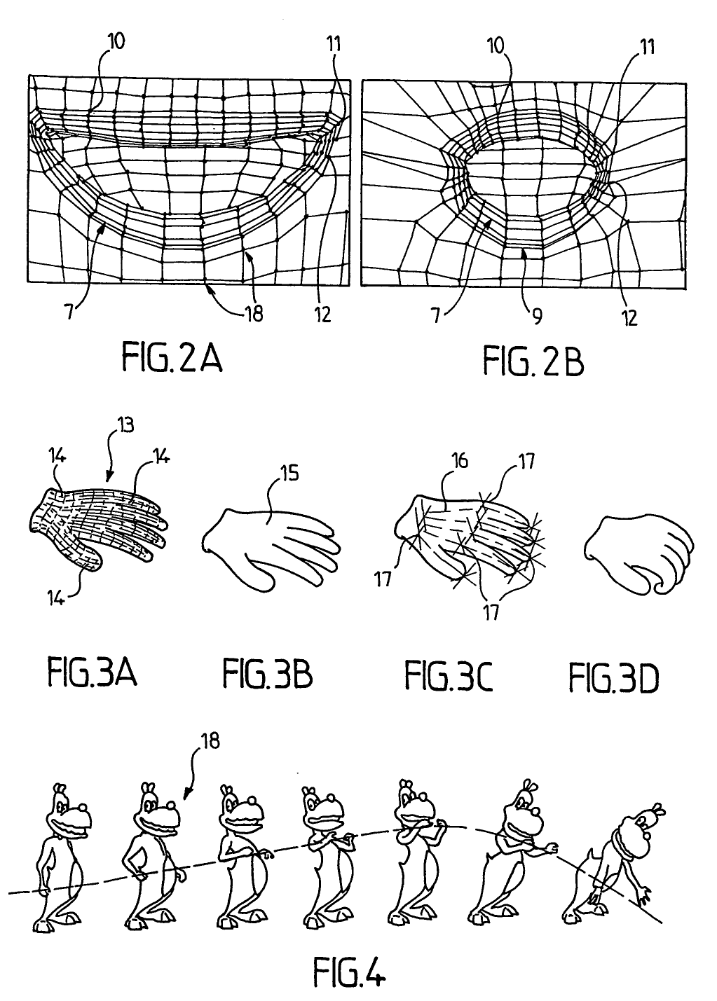

FIGS. 2A and 2B are front views of a mouth for a character capable of being used with the invention, respectively in the relaxed position and in the contracted position.

FIG. 3A to 3D give schematic perspective views of a hand of an animated agent according to one embodiment of the invention.

FIG. 4 illustrates the action of a command on an agent according to one embodiment of the invention.

FIG. 5 is a general diagram of the software architecture of the system and the method according to the embodiment of the invention more particularly described here.

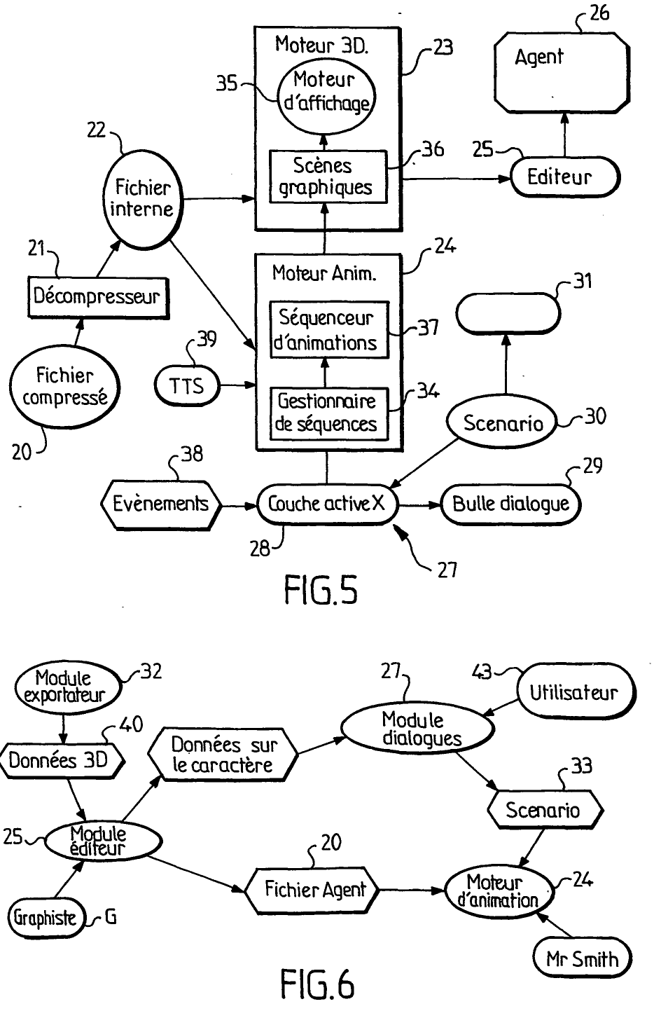

FIG. 6 shows the various interactions between the software and the users involved in the method or the system in FIG. 5.

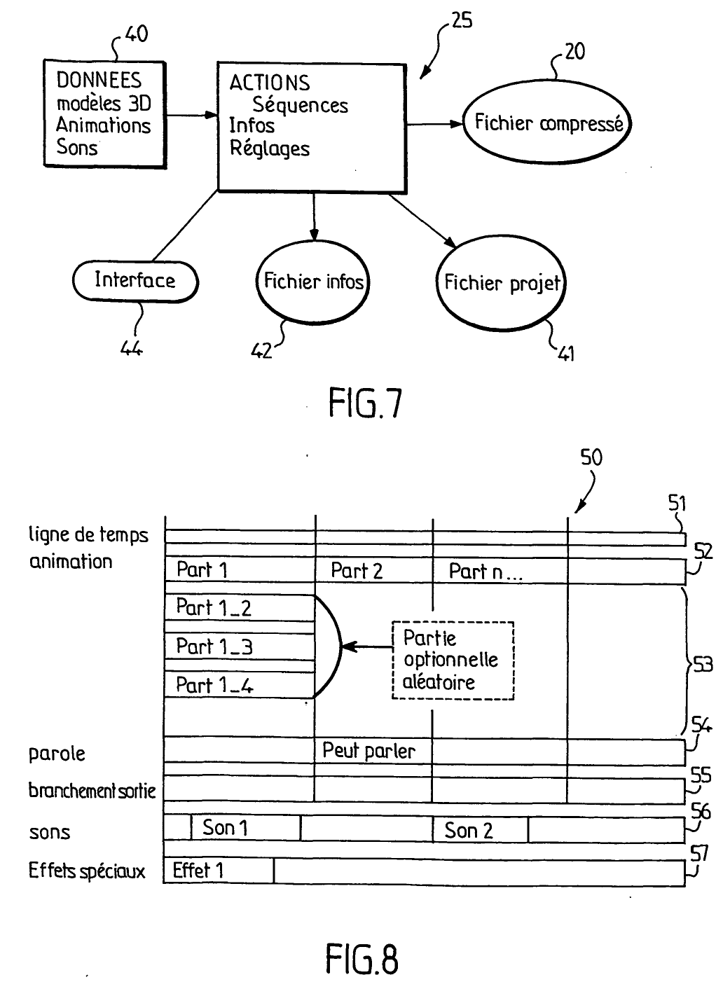

FIG. 7 is a diagram of the editor corresponding to the method carried out according to the invention.

FIG. 8 is a diagram of an edit deck of an animated agent according to one embodiment of the method of the invention.

FIG. 1 shows a display screen 1 of an application program, belonging to a PC computer (not shown) operating under Microsoft Windows, containing an agent 2 having an interactive dialog balloon 3 making it possible to display scrolling text 4. Other environments such as MAC, LINUX etc. are of course possible.

The agent 2 can be moved using a mouse (not shown) from a position 5 to a position 6, by means of a click and drag function. Its dimensions can be increased or reduced according to the user's wishes, as will be described further below.

FIGS. 2A to 3D will make it possible to better understand the means used in a known fashion to configure the agent and allow its mobility, in particular facial and/or in its limbs in the case when an agent is a small character, for example the dog 2 in FIG. 1 (cf. also FIG. 4).

More precisely, an agent is composed of a mesh of color, texture and bones, and various animation algorithms for posture and movement.

It is in fact also possible to animate the colors and the textures.

In the example of FIGS. 2A and 2B representing a mouth, deformations of the mesh 7, which are referred to as morphing, make it possible for the mouth to change from a smiling configuration 8 to a rounded configuration 9 which are not due to the bones, by movements of the points of the mesh (10, 11, 12 . . . ).

Here, the software parameterized by the graphic designer calculates the linear interpolation of each point in a manner which is known per se.

FIGS. 3A to 3D in turn, and as an example, give the successive steps in the creation of a hand 13 for its animation.

FIG. 3A shows the meshed drawing which makes it possible to outline the shape.

The artist draws the hand, front and profile, and gives instructions for the colors.

Creation under image software for three-dimensional mesh synthesis thus gives the hand 13, modeled primitively by the artist, who pulls or pushes the mesh cells 14 until the intended result is obtained.

FIG. 3B shows the hand covered with a material 15. Here, the color reacts to the positioning of the lights arranged previously around the mesh.

Various parameters corresponding to the material then allow the chosen colors to react differently. A texture is also applied to the hand at this stage.

With reference to FIG. 3C, the skin of the character having been created, the artist then integrates a skeleton 16 in order to determine the joints 17 at the intended positions of the mesh.

Each point of the mesh will then have to react as a function of the closest bones.

Finally (FIG. 3D), the animation of the hand of the character is programmed by the graphic designer with a given speed, animation keys and a determined velocity, by means of the software being employed, which is of a known type.

The character configuration work which makes it possible to obtain the character 18 in FIG. 4 is then finished. All of the data are stored in the form of a file, then separated in order to allow real-time reparameterization of the character, according to the invention, by creating a character file (first file) which is unique but which the creator (user) will be able to modify in terms of both the mesh and the colors, textures, animations, mesh morphing etc. in order to configure the various expressions determining the personality of the character.

Referring now to FIG. 5, the file obtained in this way is compressed at 20 in order to be stored. When it needs to be used, it is decompressed at 21 in order make it possible to obtain the internal file 22, or first file, which can be interpreted using the 3D engine 23 and the animation engine 24.

These data are then used to generate the agent 26 via an editor program 25, which will be described below, the nonspecialist user being able to edit the attributes of said agent 26 according to the invention by using the dialog module 27.

The user (not shown) in charge of designing the agent can then give life to his or her character in an extremely simple way.

Scripting an Agent:

The same reference numerals would in general be used below to denote the same elements in FIGS. 5, 6 and 7.

The file generated by the editor 25 is intended to be exploitable by a graphic designer G, using the libraries and documentation provided by the animation software manufacturing companies such as those mentioned above.

The put the direction of an agent 26, however, is not a straightforward task if the producer is a nonspecialist, in particular when this direction is intended to allow interaction with the agent.

Indeed, in the world of videogames, this work is generally carried out by specialist operators referred to as game designers.

According to the embodiment of the invention more particularly described here, an additional dialog module 27 is therefore provided in order to give non-programmers the opportunity to script an agent, as will now be described.

More precisely, the dialog module 27 here offers any user the opportunity to script his or her agent and automatically adapt the role of the agent so that its behavior in the application program is natural, lifelike and consistent.

The dialog module 27 is designed to write the code automatically by integrating all of the navigator detections, screen resolution, flat shape, installed voice syntheses, etc. of the application program in question.

In order to do so, it directs a so-called behavioral intelligence engine or active layer 28.

The engine is based on recognition of keywords spoken or written by the user, for example via a dialog balloon 29.

Since the script 30 is conversational and therefore limited, certain words or events are firstly cataloged and integrated in a server client database 31.

It is not necessary to understand the actual content of the conversation, but simply to recognize certain words and/or certain word associations related to a client, in order to find what the behavior of the agent should be.

### EXAMPLE 1

At 30, the user asks his or her agent to say: “We no longer have this book in stock, I am sorry, we will inform you as soon as we have it” (balloon 29).

According to the embodiment of the invention more particularly described here, simple recognition of the word “sorry” affects the way in which the agent 26 may behave, and does so in real time while it is saying its text.

The character is therefore no longer static while it is speaking.

### EXAMPLE 2

The user makes the agent respond with a confirmation of the type: “I have found the book you are looking for, here it is!”.

Based on this affirmation in conjunction with the exclamation mark, the behavioral intelligence engine 28 automatically generates the animation of the agent 26 corresponding to FIG. 4 via the animation engine 24 and the 3D engine 23.

If the user decides to instruct his or her actor more precisely, he or she may also intervene to modify the choice of its animation, which would otherwise be that programmed by default.

It is therefore possible to adapt to this recognition process to the strength and the intensity of the animations.

The agent is likewise animated faster or slower, with more or less energy in movement, depending on the content of the conversation, and without the user having previously prepared different types of animation and/or having to do anything at all.

Surprisingly, it has in fact been possible to formulate sets of expressions which may correspond to any type of character and respond to any requests without having to form a database of large dimension, apart from the animations specific to a particular type of character, or those related to a precise application.

With the invention, the personalized agent can therefore speak while exhibiting intelligent behavior, thus constituting an actor which creates its scene role all by itself when given the text provided by the user/director.

The technical characteristics of the agent implemented according to the embodiment of the invention more particularly described here will now be specified not exhaustively.

Its realization is based here on a real-time 3D technology, of the type formulated by the companies SILICON GRAPHICS (OpenGL®) or MICROSOFT (DirectX), combining all the functionalities of current videogames (morphing, bones system, antialiasing, bump mapping, lip sync, texturing).

It also implements a technology known by the term “ActiveX® Technology” under Windows, allowing the agents to be used in any Windows application or from a navigator, throughout the user's office (adaptation to the user's screen resolution).

The other implementation parameters of the agent are given below:

“actor” file of the agent [very small (˜30 KB to 150 KB)] with a streaming part.

Agent not confined to a window: the character is cut away.

Fixed camera: automatic orientation of the character as a function of its position on the screen.

Connection to speech synthesis and voice recognition systems compatible with software of the Microsoft SAPI type.

Connection with databases related to the operations known by the names profiling and tracking, and/or to an artificial intelligence program, in a manner which is known per se.

Possibility of cartoon-style interactive dialog balloons, displaying the text spoken by the actor. Choice of several types of balloons according to the state of the agent.

Memory-resident interface elements which are displayed on the screen by pressing a pop-up (button, scrolling list).

Technology operating under Windows (95/98/NT 4/2000/Me and +) and under Mac (OS 8 and higher).

It is advantageously also provided for Unix, PlayStation and other platforms.

Compatible with products referred to as IE4 and +, and Netscape Navigator 4 and +.

Display of 3D polygon models. The engine is then, for example, suited to a 3D model of up to 20,000 polygons for an operating speed of at least 15 images/second.

Animation system which is optimized and automated in certain states.

Script automation system.

Systems for exporting from software called Softimage 3D, 3DS Max and Maya.

Behavioral Intelligence engine based on a dynamic dictionary of words and word associations.

The 3D animation engine 24 which can be used with the invention is, for its part, built on the real-time 3D display engine.

Its characteristics are as follows:

scene management (objects, lights, camera)

skin: deformable hierarchic models

Texture management with filtering

Hierarchic animation

real-time inverse kinematics

real-time constraint system

additive morphing: a mesh can have a plurality of configurations of the same time, with different weightings, all this being added to the skin system.

The elements which are implemented will now be described in detail below with reference to FIG. 6.

FIG. 6 shows four main software modules which are used with the embodiment of the invention more particularly described here, namely the animation engine 24, the dialog module 27, an exporter module 32, and the editor module 25.

The animation engine 24 installed on the user's computer manages the behavior of the character controlled by the script 30 (or 33).

It interprets the 3D data, the procedures which are used, the events required of the mesh, as well as the management of its expressions and the varyingly developed autonomy which it is to have on the screen.

It uses the following parameters:

The Sequences (Data and Procedures):

A sequence is defined as an object which combines data and procedures.

The data relate to the 3D animation, the actor, the accessory objects, the sounds, the special effects.

For their part, the procedures respond to questions such as: “how should the animation unfold, how to manage a particular event, when and how the actor speaks, what the special effects do, etc.”.

The intelligent part of the agent resides in the sequences. They are initiated either directly by the script 30 (or 33) or by the engine 24 in automatic mode during dead-time management or an event.

The sequence manager 34 (see FIG. 5) controls the display engine 35 by transmitting animations or graphics scenes 36 to it and by controlling the running of these animations (animation sequencer 37). It also shows and hides the accessory objects which are used by certain animations.

The Events:

The events 38 (see FIG. 5) are due the interactions of the user with the agent (e.g.: moving the agent by moving the mouse). Management of these events is therefore necessary in order to initiate specific animations.

In order to increase the realism of the agent, for example, management is provided for the click fields on the agent, which will react differently depending on whether its eye or its body is clicked on. It is therefore necessary for the engine 24 to convey information about the 3D object which is clicked in the scene, in order to know which field has been affected.

For the movement, for example, there is also an animation which is initiated during the operation, with a special release management.

The Expressions:

The expression management employs a module which will be implemented by initiating a morphing program (morph), or the corresponding morphs, and it will remain until a new command of this type arrives.

The Autonomy of Character:

This part of the program intervenes when the agent is not being addressed. This is because the agent should always be active and doing something, otherwise it no longer seems alive.

In the embodiment of the invention more particularly described here, the dead times are for example divided into three time scales,

10 seconds: the actor starts to make small movements with the head, the eyes, it stands on the other foot, etc.

30 seconds: the actor starts to use accessory objects, it plays sport, etc.

1 minute: it yawns, it sleeps, it lies down, it rests, it is bored of being there without doing anything. Animations are then attributed to the various time scales in the agent editor.

It is thus possible to program a plurality of animations per level. The program will then randomly choose one of the animations to play.

The dialog module 27, for its part, is an interface that depends on the navigator being used, as well as the platform. Detection of these is therefore provided during the generation of the scripts 33 in this module.

The TTS Connection 39 (Abbreviation for Text-To-Speech):

Under Windows, there is a program called SAPI which is a “COM” interface that the speech synthesis systems implement.

It is therefore sufficient to connect to “SAPI” in order to access these systems. When the script 33 requires the agent to speak with the command actor.speak ‘text to be spoken’, the TTS connection will retransmit the following information to the system:

pointer in the text buffer memory

mouth positions.

The pointer to the text then makes it possible to manage the scrolling of the text in the dialog balloon.

The mouth positions permit the lip synchronization.

If the TTS system is not installed, or if there is no soundcard, a simulation system is provided for text scrolling and lip synchronization.

This system makes the text scroll at an adjustable “standard” speed. The mouth, for its part, is then rendered mobile by a random algorithm in a realistic way.

The Dialog Balloon 29:

For its part, the balloon constitutes a second window which will be placed beside or above the actor.

It appears only when the actor is speaking. The text then scrolls inside like a teleprinter. All of the parameters (shape, background color, font, text color, etc.) can be adjusted by the script 33. The place where the window appears is decided by the system in real time and depends on the position of the agent at that moment, the aim being to ensure that the (interactive) balloon is always completely inside the screen of the computer or office, and located above or beside the agent.

The Script (30-33):

There is nothing in particular to be done for the script to function, the latter being integrated and implementing the specified commands below.

The Commands:

MoveTo:

The script gives a target position in absolute value. The system detects where the actor is at that moment and calculates the difference, which gives the oriented movement vector.

The system has animations in which the agent:

walks on the spot. The subdivision is then as follows:

It starts to walk.

The actor must start in one of the 2D directions (right, left).

It faces the side.

It walks in a loop.

It can climb or descend.

It stops.

It returns to face the front in a resting position.

Jump above it.

Jump below it.

To this must be added the possibility of interrupting the walk at any moment, in particular when the distance to be covered is short. In this case, there may be only one step to make.

The method and the system according to one embodiment of the invention also provide the opportunity to decide whether the agent is moved via stairs for climbing or descending. Other choices are available. For example, it may:

Jump the full distance in one and then move horizontally.

Climb or descend progressively (staircase).

LookAt:

The script gives a target position in absolute value. The system detects where the actor is at that moment and calculates the difference, which gives the orientation angle of the head.

To this end, the system has four animations which give the movements for the four directions (left, right, up, down). In order to give a more precise angle, only the rotation of the head is changed in a determined range.

GestureAt:

The script here again gives a target position in absolute value. This system detects where the actor is at that moment and calculates the difference, which gives the oriented movement vector of the arm.

As for the “LookAt” instructions, the prepared animations are “gestureLeft, right, up and down”. In this case, the system will modify the position of the arm so that it indicates the direction more precisely, by using the inverse kinetics.

If the end user moves the character while it is speaking in a GestureAt position, the angles are recalculated and the position of the arm is modified.

The options are, for example and without implying limitation:

choice of the gesturing arm (right or left if it is a biped)

mix of animation between the various types of GestureAt!

Click:

### EXAMPLE

The animator prepares an animation in which the actor hides its right eye with both its hands.

The system initiates this animation when the right eye is clicked on. A set of small animations thereby contribute to improving the realism of the actor. The impression is obtained that it is really alive. This configuration is carried out in the agent editor 25.

RightClick:

This command manages, in particular, the initiation of a pop-up menu containing the base commands. These commands will call the animation sequences provided previously.

DoubleClick, Drag&Drop: These functions are known per se.

The functions of the exporter module 32 will now be described in more detail.

The data of an agent are in fact, and first of all, exported by a variety of 3D creation software, in order to parameterize and implement the 3D data 40 corresponding to what will be animated using the method according to the invention more particularly described here.

A so-called base scene, which includes the agent in said scene with the correct camera framing and the correct lighting, is exported first. This is the so-called sprite position of the agent.

A special scene referred to as morphs, which contains only the various morphing keys for the expressions and the mouths, is then exported.

Table No. 1 below represents the data which the graphic designer will prepare, as an example. The numbers correspond to the frame numbers in the 3D creation software.

TABLE NO. 1

| No. | content |
|---|---|
| 0 | Default shape |
| 1 | Mouth closed |
| 2 | Mouth half-open |
| 3 | Mouth wide-open |
| 4 | Ehhh |
| 5 | Ooooh |
| 6 | Smiling |
| 7 | Sad |
| 8 | Angry |
| 9 | Surprised |
| 10 | Circumspect |
| 11 | Left eyelid closed |
| 12 | Right eyelid closed |

Here, the program of the exporter module will detect the vertices which have moved and export only these.

Lastly, the animation files are read.

The editor module 25, also represented in FIG. 7, for its part makes it possible to recover the 3D data 40 and to prepare all of the settings specific to the agent 26.

More precisely, the editor 25 exports three types of files:

The compressed agent file 20, which will be used by the engine 24.

A project file 41, which will contain pointers to the source files which are used and the various settings.

A text file 42 describing the animations, for the attention of the user 43 (see FIG. 6) who will animate the agent via the interface 44.

The editor module 25 implements:

The general information and settings concerning the agent (name, language, size, TTS, etc.).

The sequences (looping, sound, etc.).

The morphs (visualization and tests) (mouths, expressions).

The setting of the movements.

The settings of the dead times.

Lastly, the dialog module 27 is composed of an edit deck 50 (cf. FIG. 8), tailored for nonlinear use of the sequences.

The edit deck 50 is hence divided into a plurality of tracks, for example into seven tracks, 51, 52, 53, 54, 55, 56 and 57 pertaining to the various parts of a sequence.

An example of sequence creation will now be described:

a new sequence is defined, to which a name is given. This sequence corresponds to one of the predefined sequence types: (show/hide, speak, etc.)

the 3D data are imported from a previously exported file 40.

the animation is subdivided into several parts (Part 1, Part 2, Part n . . . ), which are named and for which the entry and exit points are determined (cf. FIGS. 52 and 53 plotted against time, the scale of which is shown in line 1).

On the basis of this, the elements necessary for the editing are available (speech 54, output connection 55, sounds 56, special effects 57).

The various parts are then played. For example, the request is made to play the first part two times the right way round, then to play the third part the wrong way round, and finally to play the second part in ping-pong.

When the animation is ready, one of the parts will be selected for the speech.

Lastly, what the agent should do if the sequence is interrupted right in the middle is defined.

The principle used in the embodiment of the invention more particularly described here will now be described, concerning the initiating “keyword”.

There are in fact two possible directions for analyzing a text: either it is necessary to understand the meaning of the text or it is necessary to find the rhythm of the text.

In a preferred embodiment, the rhythm of the text is analyzed.

The rhythm is a general movement (of the sentence, of the poem, of the verse, of a line) which results from the relative length of the members of the sentence, the use of a tonic stress, deferments, etc.

A sentence is broken down into rhythm groups. The rhythm groups are not determined arbitrarily: they are imposed by the syntax groups (grammatical rhythm), by the semantic links (rhythm of the meaning), by the punctuation (the periods, the commas etc.) and by the breathing (long sentence without punctuation which requires the speaker to recover his or her breath).

There are therefore four parameters which give the rhythm of a text, the syntax groups, the semantic links, the punctuation and the breathing. The grammar is as difficult to analyze as the meaning, and in order to split up an overly long sentence, it also necessary to know the meaning of the sentence (a division cannot be made just anywhere).

In an advantageous embodiment, the punctuation which is present will therefore be used instead.

This in fact presents advantages.

All alphabet-based languages use basically the same punctuation.

There are only a few punctuation marks, and therefore not a large dictionary.

Each mark has a well-defined meaning.

A sequence of punctuation marks can thus give indications about the style which the user wanted to give his or her text.

For example, the animation “unsure” is played when a question mark is encountered, and movement takes place when a period is encountered, etc.

Continuing this over a text of twenty sentences, for example, there may be twenty movements and three “unsures”.

The use of a single “punctuation” parameter may therefore not be sufficient.

Whatever the case, an excellent animation result is surprisingly obtained by using the rhythm of the text, and by placing and parameterizing the commands according to this rhythm and the user selection (choice of a style).

In a preferred case, the analysis of the text makes it possible to detect the punctuation elements and the subdivision of the text (paragraphs, sentences etc.).

This text will be referred to below as the “descriptive text”.

The analysis of the descriptive text makes it possible to discover a rhythm, for example “long sentence, short interrogative sentence, short imperative sentence . . . long sentence”.

The results of this analysis are qualified with terms such as “short” or “very short” or “interrogative”. These are relative values: for example, the notion “short sentence” relates to the size of the paragraph of which it forms part.

In this way, what is referred to as a fuzzy text is defined.

Hence, by asking the user to choose a performance style for his or her agent, this makes it possible to frame his or her request better.

Each style corresponds to a parameter list, which are referred to as style parameters.

The tool according to the invention will therefore advantageously integrate a knowledge base, which will be referred to as a style reference.

The choices of commands and the moments at which said commands are inserted are then done by a program referred to as brain. It is the brain which gives the performance of the agent its tonality.

If the rule base is defined sufficiently, the agent will therefore react as a function of the user's compositional style.

Let us recall the definition of style. A style is a way of using the means of expression of the language, particular to an author, a literary genre, etc. A clear, precise, elegant style, an obscure, turgid style, a burlesque, oratory, lyrical style or administrative, legal style will thus be spoken of.

In one embodiment of the invention, the punctuation is used to determine the majority of the places at which an action of the actor may be inserted.

More precisely:

The period: the period indicates the end of a sentence. It marks a complete descent of the voice and a long pause before the voice rises again for another sentence. The period is most often used when expressing a new idea which does not have a close relation with that expressed in the preceding sentence.

The comma: the comma can be used to separate different elements of the sentence; it marks a pause without the voice dropping. The comma makes it possible to insert information, mark detachment, makes it possible to give a chronology to events or not to repeat the coordinate conjunction.

The semicolon: the semicolon separates two propositions. The two propositions most often have a logical relation between them.

It indicates that a longer pause is being marked than with the comma.

The colon: the colon has several uses. It makes it possible to list elements, to quote or report the words of someone, to express an explanation.

The exclamation mark: this is placed at the end of a sentence in which the person speaking or writing expresses an order, a wish, surprise, exasperation, admiration, etc.

The question mark: this is placed at the end of an interrogative sentence.

Parentheses: these are used to isolate information within a sentence. The group of words or the sentence between parentheses has no syntax link with the rest of the sentence. It is often a thought made by the reader a propos of such or such a passage of the sentence.

Inverted commas: these frame a sentence or a group of words which do not belong to the author, but which are borrowed from another person.

The ellipsis: this can have several values. It occurs in a list which it is desired to lengthen. It occurs when the person who is speaking (or who is writing) wishes to imply a continuation.

The comma is the commonest punctuation element and the most difficult to interpret. This is why the study of the punctuation of a text should reveal punctuation element sequences.

According to embodiments of the invention, the pagination will also be used, i.e. the carriage return, the descriptive text (which represents the division of the text into simple elements), in order to insert actions, or again the notion of fuzzy text.

For the brain to be able to determine the moment at which a command should be inserted, and which command to insert, it is in fact necessary to fill out a list of parameters that the brain will understand.

It is not, however, possible to work on the basis of a predefined form of text and look for the common points between a reference text and a text to be analyzed.

This is because each text will be different and will have its peculiarities.

It is therefore necessary to find parameters which adapt to the text. To this end, the text studied as an analysis reference should be taken as a benchmark.

This is what the invention does in one of its embodiments by using “fuzzy” parameters.

The advantage of a fuzzy parameter is that it has a precise significance for the brain, irrespective of the content. For example it is desirable to know the length of a paragraph of a text, because if a paragraph is “short” the agent will be made to move while it is reciting the paragraph.

It is the change of rhythm which is of interest.

The fuzzy parameter list should be checked and adjusted empirically.

Each fuzzy parameter has several values which are viewed in two ways. A linguistic way and a mathematical way.

The linguistic way makes it possible to understand intuitively.

For example, it is better to indicate that the paragraph is long rather than to indicate that the paragraph has a length of 0.8.

The value 0.8 will be used inside an equation by the brain, but it is better to utilize the linguistic notion for adjusting the settings.

Each fuzzy parameter will have a minimum value, a set of intermediate values and a maximum value.

According to one embodiment of the invention, the minimum value is chosen to be greater than zero and the maximum value is chosen to be less than 1, in order to avoid effects such as multiplication by zero.

The definition of the fuzzy parameters of the text makes it possible to create a reference. This involves, for example, the following parameters:

There is one paragraph:

Action is then taken as a function of the number of sentences.

There is one sentence. Very very short presentation.

There are two sentences. Very short presentation.

There are three or more sentences. Short presentation.

There are two paragraphs: As a function of the number of sentences per paragraph.

There is one sentence. Very short presentation.

There are two sentences. Short presentation.

There are three or more sentences. Medium presentation.

There are three or more paragraphs: Action is then as a function of the number of sentences per paragraph.

There is one sentence. Medium presentation.

There are two sentences. Long presentation.

There are three or more sentences. Very long presentation.

Space ratio (screen space):

A study is made of the ratio between what is said and the screen according to the user's choices.

None: the user has not defined any space.

Small: the user has defined a space for a part of the text.

Large: the user has defined a space for all of the text.

Very large: the user has several spaces.

The fuzzy parameters of a paragraph are moreover, and for example, as follows:

Valuation:

The valuation describes the spacing (number of carriage returns) between two paragraphs.

N=average carriage return number of the text.

P=carriage return number with the preceding paragraph.

S=carriage number with the next return paragraph.

Valuation step: (S=P and P<=N) or (S>P and S<=N)

| | |
|---|---|
| Low: | S < P and P <= N |
| High: | S != P and (PandS) > N |
| very high: | S = P and P > N |

Length:

Description of relative length of the paragraph with respect to the text and the other paragraphs (in number of words).

N=average word number of the paragraphs.

n=word number of the paragraph in question.

| | |
|---|---|
| Very short: | n < N * 0.25 |
| Short: | N * 0.25 < n < N * 0.5 |
| Average: | N * 0.5 < n < N * 1.5 |
| Long: | N * 1.5 < n < N * 4 |
| Very long: | N * 4 < n |

Liveliness:

A study is made of the average size of the sentences of the paragraph with respect to an average size of the sentences of the text.

T=average size of the sentences of the text.

t=average size of the sentences of the paragraph.

| | |
|---|---|
| Not lively: | t > T * 2 |
| Moderately lively: | T/2 < t < T * 2 |
| Lively: | T/4 < t < T/2 |
| Very lively: | t < T/4 |

Space Ratio (Screen Space):

A study is made of the ratio between what is said and the screen according to the user's choices.

None: the user has not defined any space.

Small: the user has defined a space for a part of the paragraph.

Large: the user has defined a space for all of the paragraph.

Very large: the user has several spaces.

The fuzzy parameters of a sentence are, for their part and for example, as follows:

Type.

The type is defined with respect to the first sentence termination mark, i.e. ‘.’ or ‘:’ or ‘;’ or ‘!’ or ‘?’ or ‘ . . . ’.

Normal. The sentence ends with ‘.’.

Imperative. The sentence ends with ‘!’.

Interrogative. The sentence ends with ‘?’.

Enumerative. The sentence ends with ‘ . . . ’.

Descriptive. The sentence ends with ‘:’.

Length:

The relative length of a sentence is studied with respect to the other sentences of the paragraphs (in number of words).

N=average number of words of the sentence.

n=number of words of the sentence in question.

| | |
|---|---|
| Very short: | n < N * 0.25 |
| Short: | N * 0.25 < n < N * 0.5 |
| Average: | N * 0.5 < n < N * 1.5 |
| Long: | N * 1.5 < n < N * 4 |
| very long: | N * 4 < n |

Parentheses

Descriptive parenthesis list. Type of parenthesis and length of the parenthesis.

Simple type: contains a series of words without punctuation.

Complex type: contains punctuation.

Length.

Commas

List of length which separate the commas between them.

The style parameters are also advantageously used.

The style parameters are defined and a name is given to this style (for example serious, comical, . . . ). The parameters describe the realism of the style. The user can thus be provided with the opportunity to define his or her own styles.

Concerning the animations, the categories are filled up with animations while giving them a weight. An animation may furthermore be described as a succession of animations.

Concerning the style parameters, the values will lie between 0.1 and 0.9.

Liveliness: quiet (0.1) - - - lively (0.9).

This parameter will determine whether the actor has more or less unpredictable actions.

State: calm (0.1) - - - nervous (0.9).

This parameter will mainly affect the animation speed.

Mobility: static (0.1) - - - mobile (0.9).

This parameter will affect the movement number of the actor.

The brain decides the exact moment at which to transmit a command, and which specific command.

To do this end, for each position at which a command may be sent, it is necessary determine a set of values indicating the interest of sending a command, and what is the best command to send.

An “interest threshold” is also determined and, each time the interest exceeds the threshold, the command defined for this interest is transmitted.

The analysis of the text and of the style desired by the user will determine the command number which will be transmitted.

The analysis of the text and of the sequence of the paragraphs will initialize all of the values. The analysis of each paragraph and of the sequence of the sentences will add or remove weight to/from the values, in respect of the paragraphs.

The analysis of the sentences and of the punctuation sequences within the sentences will add weight to the values, in respect of the sentences.

Once all of the weights have been filled in, the threshold is determined so as to transmit the intended command number (or the closest number).

Places at Which a Command can be Transmitted.

A weight is associated with each place in the text at which a command can be transmitted.

For example:

at the start of the text,

at the end of the text, etc.

List of Commands Which can be Transmitted.

Nine types of commands can advantageously be transmitted:

Movement, show, voice modification, pause, thinking, explanation, interpellation, interrogation, miscellaneous.

In addition to the weight associated with each place in the text at which a command can be transmitted, a weight is given for each type of command.

If a command needs to be transmitted, a command belonging to the type having the strongest weight will be chosen.

A weight is also associated with each element of each category.

This weight will be used to define which element to choose once the type of command has been determined. For example, it has been determined that an “interrogation” command needs to be launched, and there are five animations in the “interrogation” category.

The more interrogative the command is, the more an animation having a strong weight will be chosen.

In order to determine the “degree of interrogation” the weights associated with the other commands are then considered, and the weaker the weight of the other commands is with respect to the weight associated with the interrogative part, the stronger the “degree of interrogation” will be.

The animations are stored in five categories (the number of categories may be modified at the time when the tool settings are adjusted) thinking, explanation, interpellation, interrogation, miscellaneous.

An agent therefore has a set of base animations, which is for example stored in the hard disk of the system, each animation being weighted.

When a style is defined, the animations are then stored manually in the various categories while also associating a weight with them.

When the user chooses a style, the categories which will be used by the system are manufactured by mixing the base animations with the animations of the style, the style being favored. If an animation is present both in a category of the tool and in the same category of the style, it is the one defined in the style which will be taken into account.

The animation speed may also be modified. The animation speed varies between a minimum and a maximum. In order to choose the speed, the liveliness and nervousness information of the style and the weight associated with the command are combined.

The higher the weight of the command is, the slower the animation will be.

The more nervous the style the faster the animation will be.

The livelier the style is, the faster the animation will be.

A pause is characterized by its length. The length of a pause is defined by the weight of the command and by the style:

The higher the weight of the command is, the longer the pause will be.

The more nervous the style is, the shorter the pause will be.

The livelier the style is, the shorter the pause will be.

Several types of movement are also provided.

For example, aimless movement, equivalent to a pause, thinking. (Definition of spaces by the brain). Aimless movement while speaking, (Definition of space by the brain). Purposeful movement without speaking, (Use of a space defined by the user), etc.

The action “show”, for its part, uses the spaces defined by the user. This action will never be used if no space has been defined.

The following procedure is adopted in order to carry out the analysis of the fuzzy text.

When the brain analyzes the fuzzy text, it modifies each weight at all the positions where a command can be inserted. It modifies the main weight (should a command be inserted at this position or not) and the nine command choice weights. The command weight can only be increased, but the command choice weights can be increased or decreased (this involves favoring one command with respect to another and, since the weight difference between the various command is large, it must be possible to increase and decrease).

The analysis is hierarchic. All the weights of the text are modified when working on the text, all the weights of the paragraph are modified when working on a paragraph . . .

The proposed analysis should be adjusted empirically and is not exhaustive!

Number of Commands:

The number of commands is determined by the style of the actor and the length of the text. The livelier the style is, the more commands there will be, proportionally to the length of the text. This is equivalent to giving a command-number fill factor.

Analysis of the length of the text and the style

The shorter the text is, the more commands are inserted.

Number of commands=number of possible commands*(1−length of the text)*(liveliness).

The weights are initialized at each position where a command can be inserted:

Interest value=0

Movement=space ratio*mobility+liveliness

Show=ratio*mobility+state

Voice modification=0

Pause=1−state

Thinking=

Explanation=0

Interpellation=0

Interrogation=0

Miscellaneous=0

Start of text

Interest value+=10

Movement+=length of the text

Interpellation+=1

End of text

Interest value+=10

Movement+=1−length of the text

Miscellaneous+=liveliness

Analysis of the sequence of the paragraphs.

The length differences between the paragraphs are analyzed and a number is added to each interest value.

For all the values of the first paragraph interest value+=1.

For each intermediate paragraph interest value+=(0.6)+|length of the preceding paragraph

length of the current paragraph| (absolute value).

for the last paragraph interest value+=1.

Analysis of each paragraph

Start of paragraph

Interest value+=valuation

Movement+=space ratio+length

Show+=space ratio+(1−length)

Pause+=length*liveliness of the paragraph

Thinking+=(1−length)*liveliness of the paragraph

Interpellation+=(1−length)*valuation

Miscellaneous+=(random between 0 and 0.2)

End of paragraph

Interest value+=valuation/2

Pause+=valuation/2

Miscellaneous+=(random between 0 and 0.5)

Analysis of the sequence of the sentences of a paragraph

The length differences between the sentences are analyzed here, and a number is added to each interest value.

For all the values of the first sentence interest value+=1.

For each intermediate sentence interest value+=(0.6)+|length of the preceding sentence−length of the current sentence| (absolute value)

for the last sentence interest value+=1.

The following are also added if the sentences are type-classed (different type to normal, for example interrogative):

Interest value+=value of the type+value of the type of the preceding sentence.

Analysis of the sentence.

Start of sentence:

Interest value+=1*type+length

Movement+=length of the sentence

Show+=length of the sentence

Pause+=1−length

Thinking+=length+type

Explanation=2*type

Interpellation=2*type

Interrogation=2*type

Miscellaneous=random

End of sentence:

Interest value+=length

Movement+=length

Show+=length

Pause+=length

For parentheses:

Interest value+=10

Voice modification+=1−length of the parenthesis

Explanation+=length of the parenthesis

For inverted commas:

Interest value+=10

Voice modification+=1−length of the inverted commas

Interpellation+=length of the inverted commas.

Comma sequence:

Interest value+=(number of commas−number of the comma)+length

Movement+=space ratio/No. of the comma

Show+=space ratio/(number of comma−No. of the comma)

Interpellation+=1−length

Interrogation+=1−length/2+type

Semicolon:

Interest value+=length of the sentence after the semicolon

Movement=space ratio*mobility+liveliness

Show=ratio*mobility+state

Voice modification=0

Pause=1−state

Thinking=

Explanation=0

Interpellation=0

Interrogation=0

Miscellaneous=0

The present invention makes it possible to establish a link between any text and an agent role, by converting the text into fuzzy parameters then placing weights at all the positions where an action of the agent can be inserted.

This filling is carried out using equations which take into account the fuzzy parameters and the agent style that the user has chosen. The filling acts additively. The equations pertaining to the full text initialize all of the weights. The equations relating to a given paragraph then complete the weights of said paragraph, and so on . . .

As is evident, and as follows from what has been said above, the present invention is not limited to the embodiments more particularly described. Rather, it encompasses all variants.

1. A method for user animation of an interactive 3D character, referred to as an agent (2), for use during the running of an application program, the agent standing out from the background of the graphical interface of the program, from which it is independent, in which method a first file is created containing the data defining the agent and its animation algorithms in a manner which is known per se, said data including the parameters for colors, texture and mesh of said agent, characterized in that this first file is interpreted by calculating the behavior parameters of the agent (2) in real time using a 3D engine (23, 24) based on recognition of keywords spoken and/or written by the user, in order to automatically animate said agent as a function of predetermined criteria corresponding to said keywords or to a combination of said keywords.

2. The method as claimed in claim, characterized in that the first file is downloaded from sites which are present on the Internet.

3. The method as claimed in either one of the preceding claims, characterized in that the user interacts with the agent by filling interactive balloons (3).

4. The method as claimed in any one of the preceding claims, characterized in that the keywords are auto-generated at least in part by a behavioral intelligence engine (23, 24) based on a dynamic dictionary of words and word associations.

5. The method as claimed in any one of the preceding claims, characterized in that the text provided by the user is analyzed in order to determine the moment or moments at which commands of the agent are inserted, namely its animation, its movement or modification of the intonation of its voice, on the basis of the rhythm of the text, namely its general movement which results from the relative length of the members of the sentence and/or the use of a tonic stress.

6. The method as claimed in claim 5, characterized in that the rhythm of the text includes a plurality of parameters taken into account by the calculation, from among the grammatical rhythm, the rhythm of the meaning, the punctuation and/or the breathing.

7. The method as claimed in claim 6, characterized in that the rhythm of the sentences of the text which is used is analyzed relative to the size of the paragraph of which they form part, by using one or more so-called fuzzy parameters.

8. The method as claimed in claim 7, characterized in that the fuzzy parameter is taken from among the following parameters: valuation, length of the paragraph with respect to the rest of the text, liveliness, screen space ratio, type, relative length of a sentence, parentheses and/or commas.

9. The method as claimed in any one of the preceding claims, characterized in that a style parameter is assigned to the agent, namely a parameter dependent on the means of expression of the language specific to said agent.

10. The method as claimed in claim 9, characterized in that the style parameters used for defining the animation are so used according to a predetermined intensity scale, and are taken from among the liveliness, calm or nervous state, mobility.

11. The method as claimed in any one of the preceding claims, characterized in that the moment at which to send a command, and which command to send, are decided on the basis of the analysis of the text and the style which are intended by the user.

12. The method as claimed in claim 11, characterized in that the analysis of the text and of the sequence of paragraphs and/or also the analysis of each paragraph and of the sequence of the sentences weighting these values in respect of said paragraphs, and/or the analysis of the sentences and of the punctuation sequences within the sentences weighting said values, in respect of said sentences, initializes the values which are used in order to determine the threshold beyond which the command or commands will be transmitted.

13. The method as claimed in any one of the preceding claims, characterized in that the commands are selected from among the following operations: move, show, modify voice, pause, resend, explain, interpellate, interrogate.

14. A system for user animation of an interactive 3D character, referred to as an agent, for use during the running of an application program, said agent standing out from the background of the graphical interface of said program, from which it is independent, which system comprises a first file containing the data defining the agent and its animation algorithms in a manner which is known per se, said data including the parameters for colors, texture and mesh of said agent, characterized in that it comprises
means for storing said first file,
search, calculation and analysis means (23, 24, 27, 28) for interpreting this first file by calculating the behavior parameters of the agent in real time, said means comprising a 3D engine (23) based on recognition of keywords spoken and/or written by the user,
means (29) for voice recognition and/or writing of said keywords by the user,
and display means (1, 3) designed to automatically animate said agent, on the basis of said 3D engine, as a function of predetermined criteria corresponding to said keywords or to a combination of said keywords.

15. The system as claimed in claim 14, characterized in that the first file is downloaded from sites which are present on the Internet.

16. The system as claimed in either one of claims 14 to 15, characterized in that it includes means designed to allow the user to interact with the agent by filling interactive balloons.

17. The system as claimed in any one of claims 14 to 16, characterized in that it includes means for auto-generating keywords at least in part, said means comprising a behavioral intelligence engine based on a dynamic dictionary of words and word associations.

18. The system as claimed in any one of claims 14 to 17, characterized in that it comprises means for analyzing the text provided by the user in order to determine the moment or moments at which commands of the agent are inserted, namely its animation, its movement or modification of the intonation of its voice, on the basis of the rhythm of the text, namely its general movement which results from the relative length of the members of the sentence and/or the use of a tonic stress.

19. The system as claimed in claim 18, characterized in that the means for analyzing the rhythm of the text are designed for calculation according to a plurality of parameters, from among the grammatical rhythm, the rhythm of the meaning, the punctuation and/or the breathing.

20. The system as claimed in claim 19, characterized in that it comprises means for analyzing the rhythm of the sentences of the text which is used relative to the size of the paragraph of which they form part, by using one or more so-called fuzzy parameters.

21. The system as claimed in claim 20, characterized in that the fuzzy parameter is taken from among the following parameters: valuation, length of the paragraph with respect to the rest of the text, liveliness, screen space ratio, type, relative length of a sentence, parentheses and/or commas.

22. The system as claimed in any one of claims 14 to 21, characterized in that it comprises means designed to take a style parameter into account and assign it to the agent, namely a parameter dependent on the means of expression of the language specific to said agent.

23. The system as claimed in claim 22, characterized in that the style parameters used for defining the animation are so used according to a predetermined intensity scale, and are taken from among the liveliness, calm or nervous state, mobility.

24. The system as claimed in any one of claims 14 to 23, characterized in that it includes means for controlling the agent and the moment at which to send said command, on the basis of the analysis of the text and the style which are intended by the user.

25. The system as claimed in claim 24, characterized in that it is designed so that the analysis of the text and of the sequence of paragraphs initializes the values which are used in order to determine the threshold beyond which the command or commands will be transmitted, the analysis of each paragraph and of the sequence of the sentences weighting these values in respect of said paragraphs, and the analysis of the sentences and of the punctuation sequences within the sentences weighting said values, in respect of said sentences.

26. The system as claimed in any one of claims 14 to 25, characterized in that the commands are selected from among the following operations: move, show, modify voice, pause, resend, explain, interpellate, interrogate.
